(19) United States
(12) Patent Application Publication
(10) Pub. No.: US 2025/0123385 A1
(43) Pub. Date: Apr. 17, 2025

(54) METHOD, CIRCUITS, AND APPARATUS FOR MOTION DETECTION, DOPPLER SHIFT DETECTION, AND POSITIONING BY SELF-ENVELOPE MODULATION

(71) Applicant: RichWave Technology Corp, Taipei CIty (TW)

(72) Inventor: Tse-Peng Chen, Taipei City (TW)

(73) Assignee: RichWave Technology Corp, Taipei City (TW)

(21) Appl. No.: 18/988,962

(22) Filed: Dec. 20, 2024

Related U.S. Application Data
(63) Continuation-in-part of application No. 16/826,584, filed on Mar. 23, 2020, now Pat. No. 12,216,191.
(60) Provisional application No. 62/886,293, filed on Aug. 13, 2019.
(60) Provisional application No. 62/827,635, filed on Apr. 1, 2019.

(51) Int. Cl. G01S 13/58; G01S 7/35; G01S 13/62

(52) U.S. Cl. CPC G01S 13/583; G01S 7/354; G01S 13/62

(57) ABSTRACT

A circuit for detecting motion of an object in an environment. The circuit comprises a transmission chain, an envelope extraction circuit, and a detector circuit. The transmission chain includes a power amplifier, a sensing circuit, and a single antenna. By the single antenna, a first wireless signal related to a transmission signal is transmitted. The transmission signal is a continuous wave signal. The single antenna can receive a second wireless signal as an incoming signal. The second wireless signal is a reflected first wireless signal from the object. The sensing circuit can obtain a modulation signal by combining the continuous wave signal and the incoming signal. The modulation signal contains a Doppler shift caused by the motion of the object. The envelope extraction circuit can extract a signal envelope from the modulation signal. The detector circuit can determine the motion of the object according to the signal envelope.

### CROSS REFERENCE TO RELATED APPLICATION

This application is a continuation-in-part of U.S. application Ser. No. 16/826,584, filed on Mar. 23, 2020, which claims the benefit of U.S. Provisional Application No. 62/886,293, filed on Aug. 13, 2019, and claims the benefit of U.S. Provisional Application No. 62/827,635, filed on Apr. 1, 2019. The contents of these applications are incorporated herein by reference in their entirety.

### TECHNICAL FIELD

The present application relates to motion detection of an object, and Doppler shift, and more particularly, to methods, circuits, and apparatus for motion detection and position determination of an object.

### BACKGROUND

Detecting motion of an object, Doppler shifts caused by the motion, and a position of the object in an environment can be applied to various applications, such as smart home devices and systems, home security and surveillance, indoor and outdoor guide services, and interactive information systems. Motion sensors and proximity sensors can be used to detect the motion of the object. For example, passive infrared (PIR) sensors can be used to detect whether a human has moved in or out of a sensor's range. However, motion sensors and proximity sensors require additional installation of the sensors and may not be able to provide accurate and/or prompt motion detection of a variety of objects, such as an inanimate object, a human, or an animal. In addition, motion sensors and proximity sensors may not be applicable to a variety of environments, such as a large room, an open space office, a public space, or an outdoor environment.

Doppler shift detection circuits and positioning devices can be used to detect the Doppler shifts caused by the motion of the object and a position of the object. However, the Doppler shift detection circuits and positioning devices also require additional installation of the circuits and devices and may not be applicable to a variety of environments, such as multiple rooms, indoor and outdoor spaces, and various environments.

### SUMMARY

An embodiment provides a circuit for detecting motion of an object in an environment. The circuit comprises a transmission chain, an envelope extraction circuit, and a detector circuit. The transmission chain includes a power amplifier, a sensing circuit, and a single antenna coupled together. The transmission chain is configured to transmit, by the single antenna, a first wireless signal related to a transmission signal. The transmission signal is a continuous wave signal. The single antenna is configured to receive a second wireless signal as an incoming signal. The second wireless signal is a reflected first wireless signal from the object. The sensing circuit is configured to obtain a modulation signal by combining the continuous wave signal and the incoming signal, wherein the modulation signal contains a Doppler shift caused by the motion of the object. The envelope extraction circuit is configured to extract a signal envelope varied by the Doppler shift from the modulation signal. The detector circuit configured to determine detection of the motion of the object in accordance with the signal envelope.

Another embodiment provides a circuit for detecting motion of an object in an environment. The circuit comprises a transmission chain. The transmission chain includes a power amplifier, a sensing circuit, a matching circuit, and a single antenna coupled together, the transmission chain configured to transmit, by the single antenna, a first wireless signal related to a transmission signal. The transmission signal is a continuous wave signal. The single antenna is configured to receive a second wireless signal as an incoming signal, the second wireless signal being a reflected first wireless signal from the object. The sensing circuit is configured to obtain a modulation signal by combining the continuous wave signal and the incoming signal, wherein the modulation signal contains a Doppler shift caused by the motion of the object. The matching circuit is configured to adjust an impedance looked into the single antenna, and the signal envelope is configured to determine detection of the motion of the object.

### BRIEF DESCRIPTION OF THE DRAWINGS

FIG. 1 illustrates a circuit for detecting motion of an object in an environment according to an embodiment.

FIG. 2 illustrates signal waveforms related to detecting the motion of object according to embodiments.

FIG. 3 illustrates a circuit for detecting motion of an object in an environment according to an embodiment.

FIG. 4 illustrates a circuit for detecting motion of an object in an environment according to another embodiment.

FIG. 5 illustrates a circuit for detecting motion of an object in an environment according to another embodiment.

FIG. 6 illustrates a circuit for detecting motion of an object in an environment according to another embodiment.

FIG. 7 illustrates a circuit for detecting motion of an object in an environment according to another embodiment.

FIG. 8 illustrates a circuit for detecting motion of an object in an environment according to another embodiment.

FIG. 9 illustrates a circuit according to another embodiment.

FIG. 10 illustrates a circuit according to another embodiment.

FIG. 11 illustrates a circuit for detecting motion of an object in an environment according to another embodiment.

FIG. 12 illustrates a circuit for detecting motion of an object in an environment according to another embodiment.

FIG. 13 illustrates a circuit for detecting motion of an object in an environment according to another embodiment.

FIG. 14 to FIG. 18 illustrate a plurality of circuits according to embodiments.

FIG. 19 illustrates a circuit for detecting motion of an object in an environment according to another embodiment.

FIG. 20 illustrates a circuit for detecting motion of an object in an environment according to another embodiment.

FIG. 21 illustrates a circuit for detecting motion of an object in an environment according to another embodiment.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

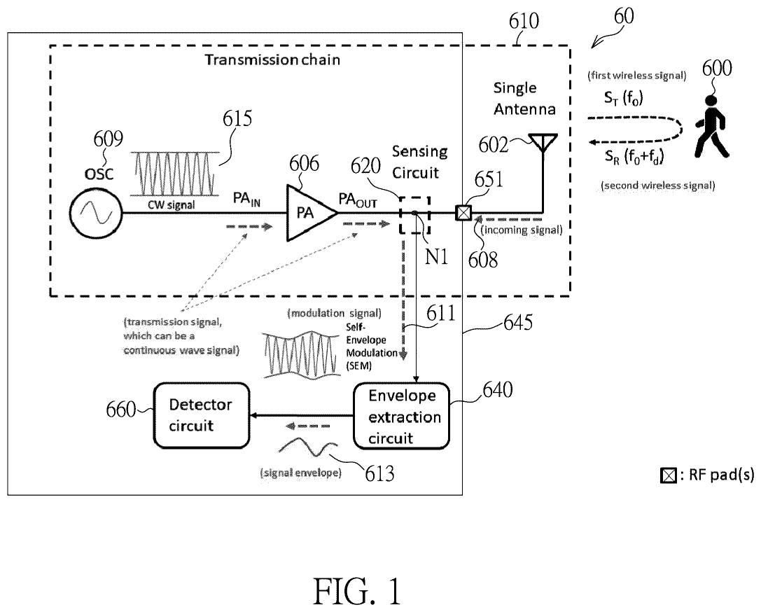

FIG. 1 illustrates a circuit 60 for detecting motion of an object 600 in an environment according to an embodiment. The circuit 60 includes a transmission chain 610, an envelop extraction circuit 640, and detector circuit 660. The transmission chain 610 can include a power amplifier 606, a sensing circuit 620, and a single antenna 602 coupled together. The single antenna described in this text refers to a single antenna, rather than multiple antennas separated in different locations. The single antenna 602 can have a single radiation unit. The transmission chain 610 can be used to transmit, by the single antenna 602, a first wireless signal S_{T}(f₀) related to a transmission signal PA_{OUT} and a transmission signal PA_{IN}. The transmission signal PA_{IN} can be amplified by the power amplifier 606 to generate the transmission signal PA_{OUT}. The transmission signal PA_{OUT} can be a continuous wave (CW) signal. The transmission signal PA_{IN} can be a continuous wave signal 615. The continuous wave signal 615 can be generated by an oscillator 609. The single antenna 602 can receive a second wireless signal S_{R}(f₀+f_{d}) to generate an incoming signal 608. The second wireless signal S_{R}(f₀+f_{d}) can be a reflected first wireless signal S_{T}(f₀) from the object 600.

For example, the single antenna 602 can transmit the first wireless signal S_{T}(f₀) at frequency f₀ toward the object 600 (e.g., a person or another detected object). When the object 600 is moving, the transmitted signal S_{T}(f₀) can be reflected from the object 600 to generate the signal S_{R}(f₀+f_{d}) with a frequency (f₀+f_{d}), where f_{d} is a Doppler shift, f_{d}=2v(f₀/c) cos θ, v is a velocity of the object 600, c is the speed of light, and θ is an angle between the object 600's forward velocity and the line of sight from the object 600 to the single antenna 602. The frequency f₀ can be a suitable frequency. If the object 600 is not moving and remains stationary, f_{d} can be 0.

In FIG. 1, the sensing circuit 620 can be used to obtain a modulation signal 611 by combining the signal PA_{OUT}(continuous wave signal) and the incoming signal 608 (corresponding to the second wireless signal S_{R}(f₀+f_{d})), where the modulation signal 611 can contain a Doppler shift caused by the motion of the object 600. The modulation signal 611 can be a self-envelope modulation (SEM) signal.

Envelope modulation can refer to a process of varying the amplitude of a carrier signal in a way that matches the envelope of the modulating signal. This involves modifying the outer shape (envelope) of a waveform to encode information. This technique can be used in communication systems to transmit data efficiently. According to the circuit in FIG. 1, the disclosure may perform signal combination in the sensing circuit 620 to generate the self-envelope modulation signal 611, which is used to determine whether an object is moving based on the signal's envelope.

The envelope extraction circuit 640 can be used to extract a signal envelope 613 varied by the Doppler shift from the modulation signal 611. The detector circuit 660 can be used to determine detection of the motion of the object 600 in accordance with the signal envelope 613.

The sensing circuit 620 can be coupled to the single antenna 602 through a bonding pad 651. The bonding pad 651 can be a radio-frequency (RF) pad. In FIG. 1, the circuit 60 is a structure with a single antenna and a single RF pad. The pad described herein may serve as an interface between the internal and external parts of an integrated circuit (IC) and can be used in processes such as packaging and wire bonding to integrate the integrated circuit into other devices.

In the circuit 60 of FIG. 1, the single antenna 602 can be outside the integrated circuit (IC), and components other than the single antenna 602 can be on the IC 645. That is, the components to the left of the bonding pad 651 in FIG. 1 (e.g., the oscillator 609, the amplifier 606, the sensing circuit 620, the envelope extraction circuit 640, and/or the detector circuit 660) can be on the IC 645. Therefore, a part of the transmission chain 610 can be on the IC 645, and the other part (e.g., the single antenna 602) can be outside the IC 645.

In FIG. 1, the components located to the left of the bonding pad 651 can be disposed on the same IC. However, this is a schematic diagram used to explain this disclosure and is not used to limit the actual circuit layout.

In the figures of this document, the components shown to the left of the bonding pad 651 are only for the purpose of explaining that the components can be disposed on the IC, and are not intended to limit the actual layout of the circuit. The positions and directions of the components can be adjusted according to actual needs.

In FIG. 1, the sensing circuit 620 can include a node N1 coupled to and between the amplifier PA, the single antenna 602, and the envelope extraction circuit 640. Since sensing circuit 620 can be a node, the circuit's area and complexity can be effectively reduced.

The following process can be used based on FIG. 1 to determine whether the object 600 is moving.
Step A: Use the oscillator 609 to generate the continuous wave signal 615 as the transmission signal PA_{IN} (where the transmission signal PA_{IN} can be a continuous wave signal);
Step B: The power amplifier 606 amplifies the transmission signal PA_{IN} to generate the transmission signal PA_{OUT} (where the transmission signal PA_{OUT} can be a continuous wave signal);
Step C: Use the single antenna 602 to wirelessly transmit the first wireless signal S_{T}(f₀) based on the transmission signal PA_{OUT} to detect the object 600;
Step D: Use the single antenna 602 to receive the second wireless signal S_{R}(f₀+f_{d}), where the first wireless signal S_{T}(f₀) is reflected by the object 600 to generate the second wireless signal S_{R}(f₀+f_{d}), and f_{d} can be the Doppler shift, f_{d} can be 0 if the object 600 is stationary, and f_{d} can be non-zero if the object 600 is moving;
Step E: Generate the incoming signal 608 based on the second wireless signal S_{R}(f₀+f_{d});
Step F: Combine a continuous wave signal corresponding to the transmission signal PA_{IN} and the incoming signal 608 in the sensing circuit 620 to generate the modulation signal 611, where the modulation signal 611 can be a self-envelope modulation (SEM) signal;
Step G: Use the envelope extraction circuit 640 to process the modulation signal 611 to generate the signal envelope 613; and
Step H: Use the detector 660 to determine whether the object 600 is moving based on the signal envelope 613.

In the text and figures of this disclosure, TX can represent transmission, RX can represent reception, GND can represent the ground voltage terminal, VDD and VCC can represent predetermined voltage terminals, RF can represent radio frequency, DC can represent direct current, AC can represent alternating current, CW can represent continuous wave, and IF can represent intermediate frequency. A pad described in this disclosure can be a conductive pad of a bare die or an encapsulated IC, which can be in the form of a conductive pin, conductive ball, or other suitable forms.

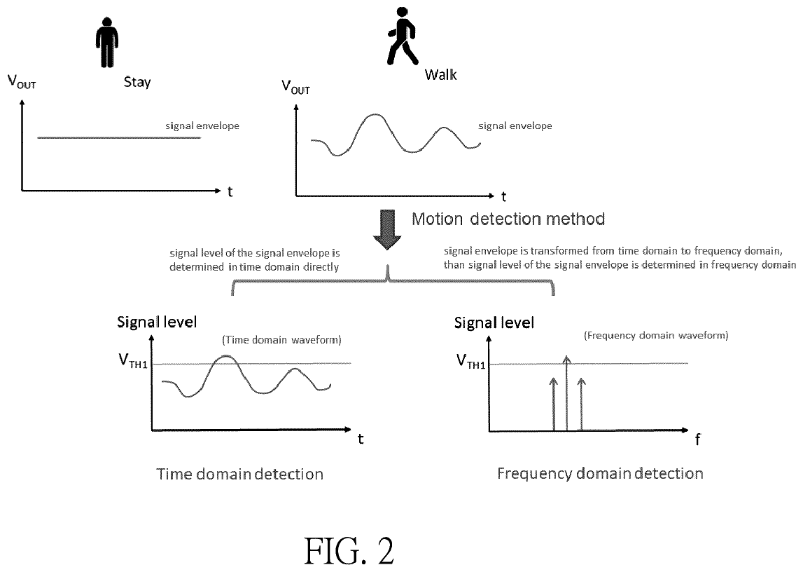

FIG. 2 illustrates signal waveforms related to detecting the motion of object 600 according to embodiments. As shown in FIG.1 and FIG. 2, the detector circuit 60 can further be used to determine whether a signal level of the signal envelope 613 exceeds a predetermined threshold, and responsive to the determination that the signal level of the signal envelope 613 exceeds the predetermined threshold, determine detection of the motion of the object 600.

In FIG. 2, the detected object can be a person. When the person is not moving, it is labeled as “stay”, and the waveform of the signal envelope 613 below remains constant (or varies slightly). When the person is walking, the movement can be detected and labeled as “walk”, and the waveform of the signal envelope 613 below varies (or varies significantly). However, FIG. 2 is just an example. According to embodiments, the detected object is not limited to humans, and it can be other objects such as cars, animals, or any desired objects to be detected.

In FIG. 2, if the horizontal axis is labeled t, it represents time and corresponds to the time domain. If the horizontal axis is labeled f, it represents frequency and corresponds to the frequency domain. In FIG. 2, the level V_{OUT} can be the signal level of the signal envelope 613. As shown in FIG. 2, if the waveform of the signal envelope 613 exceeds the predetermined threshold V_{TH1}, the circuit 60 can be determined that the object 600 is in motion rather than at rest.

In FIG. 2, the waveform of the signal envelope 613 used to determine whether the object 600 is moving can also be a signal waveform in the frequency domain. Hence, the detector circuit 660 can further be used to determine whether the signal level of the signal envelope 613 exceeds the predetermined threshold V_{TH1} in frequency domain; and responsive to the determination that the signal level of the signal envelope 613 exceeds the predetermined threshold V_{TH1} in frequency domain, determine detection of the motion of the object 600.

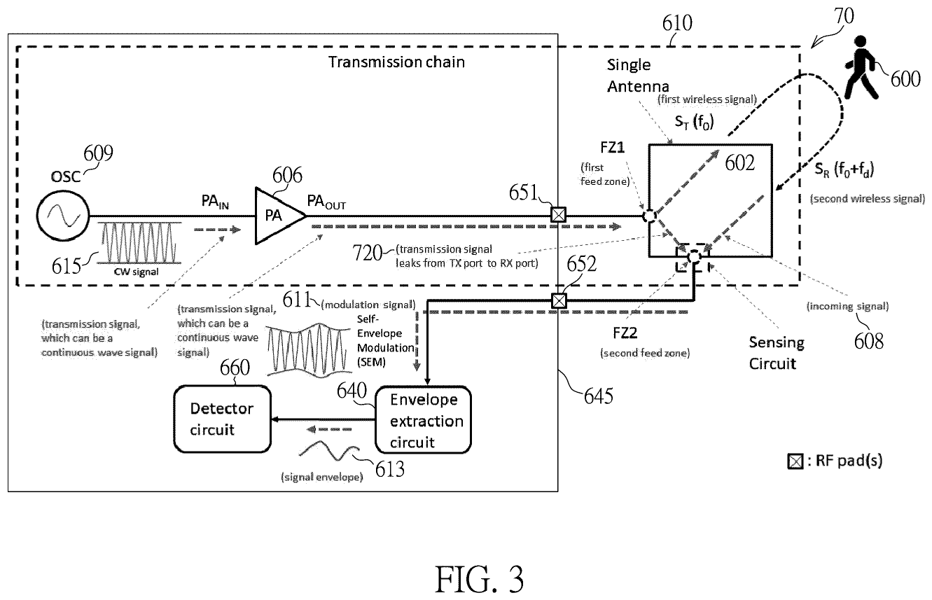

FIG. 3 illustrates a circuit 70 for detecting motion of an object 600 in an environment according to an embodiment. The similarities between FIG. 3 and FIG. 1 will not be reiterated. In FIG. 3, the single antenna 602 can include a first feed zone FZ1 and a second feed zone FZ2. The first wireless signal S_{T}(f₀) can be transmitted by the single antenna 602 through the first feed zone FZ1. The second wireless signal S_{R}(f₀+f_{d}) can be received by the single antenna 602 as the incoming signal. In FIG. 3, the operation of the sensing circuit can be performed on the single antenna 602. In FIG. 3, the sensing circuit can obtain the modulation signal 611 (i.e. the SEM signal) through the second feed zone FZ2 by combining an incoming signal 608 and a signal 720, where the signal 720 can be a transmission signal leaked from the first feed zone FZ1 to the second feed zone FZ2. The sensing circuit can be formed by the second feed zone FZ2. An isolation between the first wireless signal S_{T}(f₀) and the second wireless signal S_{R}(f₀+f_{d}) may not be less than 7 dB and not greater than 60 dB.

For example, the isolation may be greater than 8 dB. The isolation between the first wireless signal S_{T}(f₀) and the second wireless signal S_{R}(f₀+f_{d}) can be not greater than 60 dB which is more suitable for the SEM signal. By adjusting the locations of the feed zones FZ1 and FZ2 of the single antenna 602, the isolation can be tuned to a suitable value. In this embodiment, the single antenna 602 can be a non-orthogonal polarized antenna to provide the suitable isolation value.

Due to the isolation being between 7 dB and 60 dB, the single antenna 602 can generate the leaked signal 720 to achieve the effect of combining signals, thereby generating the modulation signal (the SEM signal 611) to determine whether the object 600 is moving.

In FIG. 3, the bonding pad 651 can be between the power amplifier PA and the single antenna 602, and a bonding pad 652 can be between the envelope extraction circuit 640 and the single antenna 602. Therefore, the circuit 70 of FIG. 3 can have two RF bonding pads. Similar to FIG. 1, in FIG. 3, the single antenna 602 can be off the IC 645, while other components can be on the IC 645. That is, an internal reception chain can be formed via the bonding pad 652, the envelop extraction circuit 640 to the detector circuit 660 inside the IC 645, and the part of the transmission chain 610 inside the IC 645 and the internal reception chain are separate. Furthermore, the part of the transmission chain 610 inside the IC 645 and the internal reception chain can be AC-uncoupled.

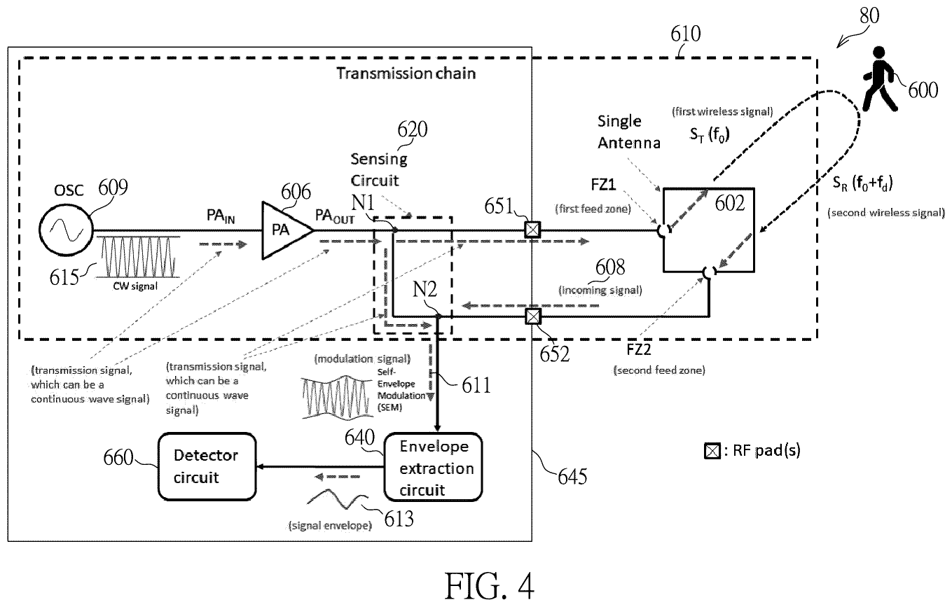

FIG. 4 illustrates a circuit 80 for detecting motion of an object 600 in an environment according to another embodiment. The similarities between FIG. 4, FIG. 1, and FIG. 3 will not be reiterated. In FIG. 4, the single antenna 602 can include a first feed zone FZ1 and a second feed zone FZ2. The first wireless signal S_{T}(f₀) can be transmitted to the single antenna 602 through the first feed zone FZ1. The second wireless signal S_{R}(f₀+f_{d}) can be received by the single antenna 602 as the incoming signal 608. The sensing circuit 620 can be used to obtain the modulation signal 611 by combining the transmission signal PA_{OUT} (corresponding to the CW signal 615) and the incoming signal 608. In FIG. 4, the sensing circuit 620 can include two nodes N1 and N2. The node N1 can be coupled to the power amplifier PA, the single antenna 602, and the envelope extraction circuit 640. The node N2 can be coupled to the node N1, the single antenna 602, and the envelope extraction circuit 640. An internal RF signal can be transmitted between the nodes N1 and N2. In this embodiment, the single antenna 602 can be a dual-orthogonal polarization antenna, and its isolation between the first wireless signal S_{T}(f₀) and the second wireless signal S_{R}(f₀+f_{d}) may greater than 60 dB.

In FIG. 4, a portion of the signal components can be transmitted from the single antenna 602 to the node N1 via the node N2 to combine with the transmission signal PA_{OUT}, and the internal RF signal can be combined with the incoming signal 608 at the node N2 and/or the node N1. Therefore, the sensing circuit 620 can combine the wireless signal S_{T}(f₀) with the wireless signal S_{R}(f₀+f_{d}) to generate the modulation signal 611 (i.e. SEM signal) to determine whether the object 600 is moving.

The sensing circuit 620 can be coupled to feed zone FZ1 through the bonding pad 651, and the sensing circuit 620 can be coupled to feed zone FZ2 through the bonding pad 652. Therefore, the circuit 80 can have two RF bonding pads. The single antenna 602 can be off the IC 645, while other components can be on the IC 645.

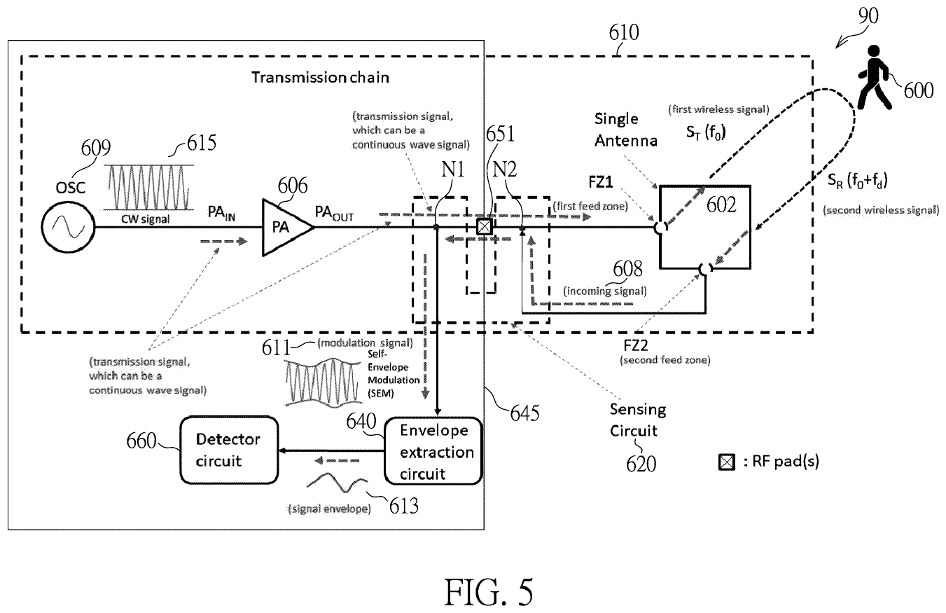

FIG. 5 illustrates a circuit 90 for detecting motion of an object 600 in an environment according to another embodiment. The similarities between FIG. 5 and FIG. 4 will not be reiterated. In the circuit 90, the incoming signal 608 generated according to the second wireless signal S_{R}(f₀+f_{d}) can be transmitted to the node N2 to be combined with the transmission signal PA_{OUT} (which is a CW signal), and the combined signal can be combined at the node N1 to generate the modulation signal 611. The modulation signal 611 can be input into the envelope extraction circuit 640 to determine whether the object 600 is moving. In this embodiment, the single antenna 602 can be a dual-orthogonal polarization antenna, and its isolation between the first wireless signal S_{T}(f₀) and the second wireless signal S_{R}(f₀+f_{d}) may greater than 60 dB.

The circuit 90 can have a bonding pad 651 located between the nodes N1 and N2. The structure of the circuit 90 can have a single RF bonding pad rather than two RF bonding pads. In the circuit 90, the single antenna 602 can be off the IC 645, while other components can be on the IC 645.

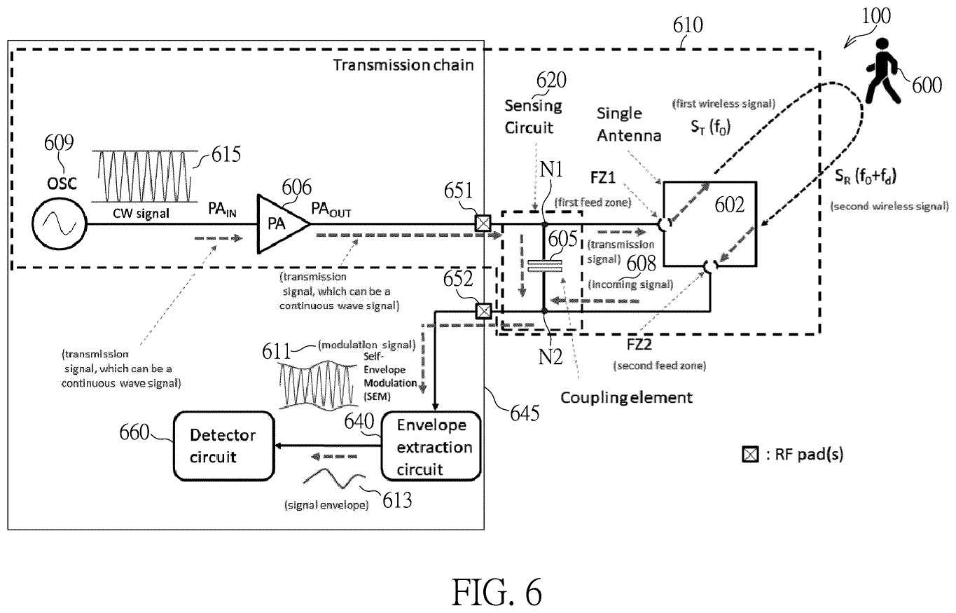

FIG. 6 illustrates a circuit 100 for detecting motion of an object 600 in an environment according to another embodiment. The similarities between FIG. 6, FIG. 1, and FIG. 3 to FIG. 5 will not be reiterated. The circuit 100 can include a coupling element 605. The coupling element 605 may be a capacitor, a passive component, or a circuit composed of multiple passive components.

A first terminal of the coupling element 605 can be coupled to the feed zone FZ1 of the single antenna 602, and a second terminal of the coupling element 605 can be coupled to the feed zone FZ2 of the single antenna 602. The second wireless signal S_{R}(f₀+f_{d}) can be received by the single antenna 602 as the incoming signal 608. The sensing circuit 620 can generate the modulation signal 611 by combining the continuous wave signal (i.e. the transmission signal PA_{OUT}) through the coupling element 605 and the incoming signal 608 transmitted through the feed zone FZ2. In this embodiment, the single antenna 602 can be a dual-orthogonal polarization antenna, and its isolation between the first wireless signal S_{T}(f₀) and the second wireless signal S_{R}(f₀+f_{d}) may greater than 60 dB.

The circuit 100 can have the bonding pads 651 and 652. The bonding pad 651 can be located between the power amplifier 606 and the first terminal of the coupling element 605, and the bonding pad 652 can be located between the envelope extraction circuit 640 and the second terminal of the coupling element 605. Therefore, the structure of circuit 100 can have two RF bonding pads. In FIG. 6, the aforementioned combining operation may be performed outside the IC 645 to generate the modulation signal 611. That is, an internal reception chain can be formed via the bonding pad 652, the envelop extraction circuit 640 to the detector circuit 660 inside the IC 645, and the part of the transmission chain 610 inside the IC 645 and the internal reception chain are separate.

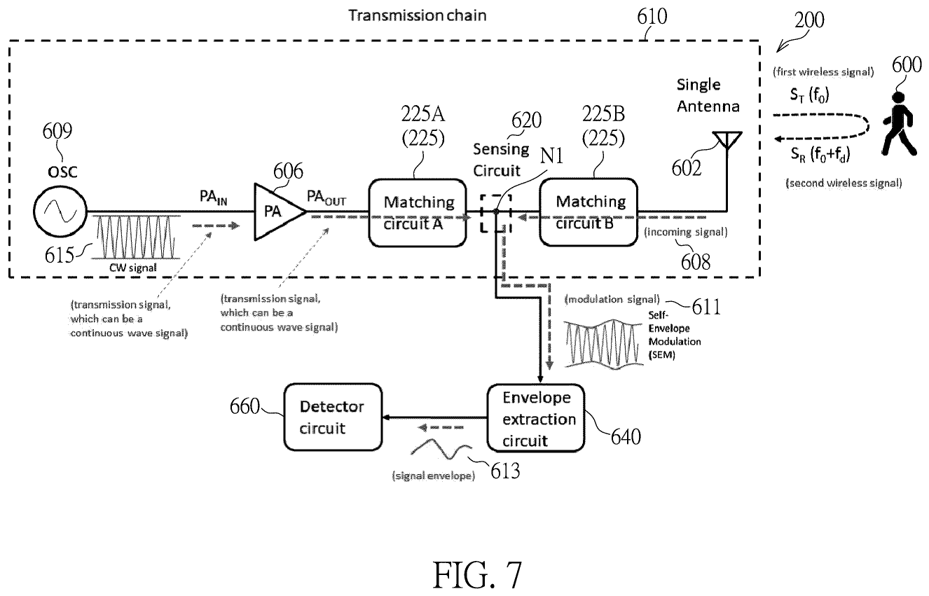

FIG. 7 illustrates a circuit 200 for detecting motion of an object 600 in an environment according to another embodiment. The similarities between FIG. 7, FIG. 1, and FIG. 3 to FIG. 6 will not be reiterated. In the circuit 200, the transmission chain 610 can further include a matching circuit 225 used to adjust an impedance looked into the single antenna 602. In FIG. 7, the transmission chain 610 includes a matching circuit 225A and a matching circuit 225B. Each of 225A and 225B is included by the matching circuit 225. However, depending on the requirements, it is not necessary to use both the matching circuits 225A and 225B simultaneously. The matching circuits 225A and 225B can be used either both together or individually, and this falls within the scope of the embodiments.

In FIG. 7, a bonding pad can be located between the sensing circuit 620 and the single antenna 602, for example, between the sending circuit 620 and the matching circuit 225B. In the circuit 200, the matching circuit 225 can be inside and/or outside the IC. For example, if the bonding pad is located between the sensing circuit 620 and the matching circuit 225B, then the matching circuit 225A can be inside the IC, and the matching circuit 225B can be outside the IC.

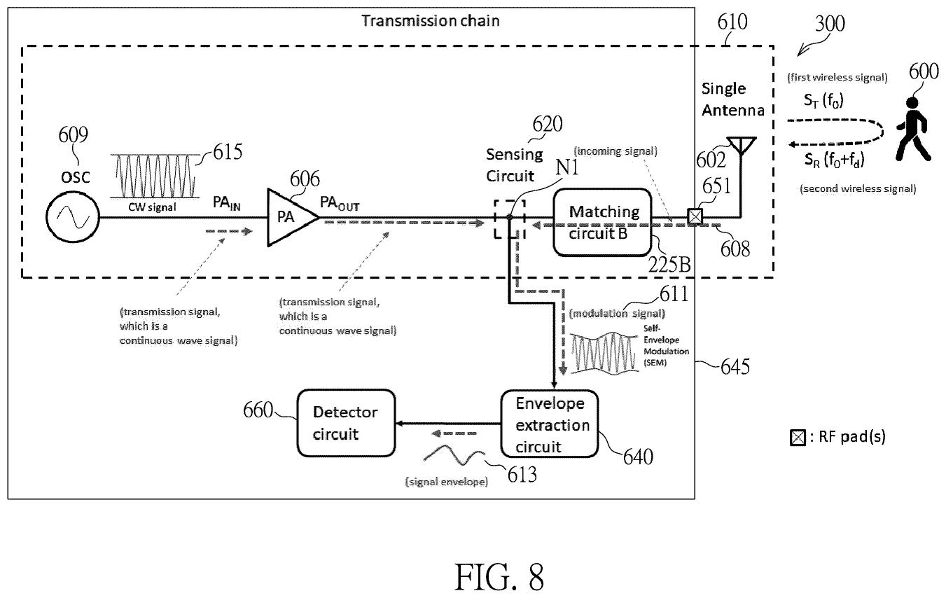

FIG. 8 illustrates a circuit 300 for detecting motion of an object 600 in an environment according to another embodiment. The similarities between FIG. 8, FIG. 1, and FIG. 3 to FIG. 7 will not be reiterated. The transmission chain 610 of the circuit 300 can include the matching circuit 225B located between the sending circuit 620 and the single antenna 602. The circuit 300 can include a bonding pad 651 located between matching circuit 225B and the single antenna 602. Therefore, the structure of circuit 300 can have a single RF pad, and the matching circuit 225B can be inside the IC 645, which can provide more compact configurations.

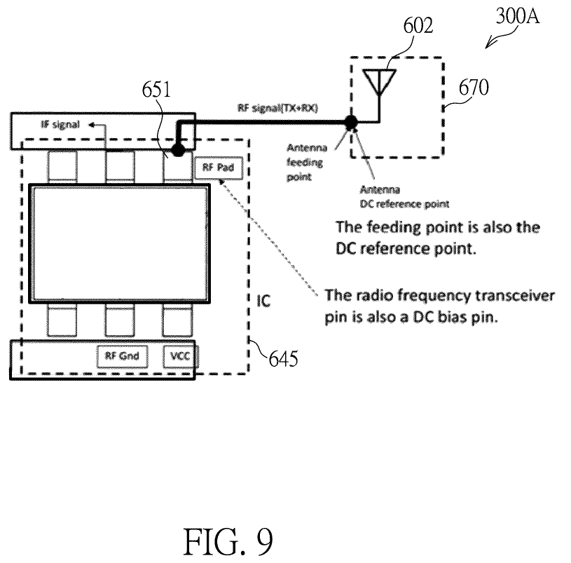

FIG. 9 illustrates a circuit 300A according to another embodiment. In FIG. 9, the power amplifier PA, the sensing circuit 620, the envelope extraction circuit 640, and the detector circuit 660 can be disposed in an IC 645. The IC 645 can include a bonding pad 651. The bonding pad 651 can be the same bonding pad to provide RF signal transmission between the power amplifier PA and the single antenna 602 of the transmission chain 610, and between the single antenna 602 and the envelope extraction circuit 640 of the transmission chain 602. As shown in FIG. 9, the single antenna 602 can be disposed on an antenna element 670. In FIG. 9, the antenna element 670 can include an antenna feeding point for receiving and transmitting RF signals, as well as for receiving a DC reference bias voltage.

The IC 645 of the circuit 300A can have a single RF pad (e.g., the bonding pad 651) to couple the single antenna 602 to the IC 645. In the circuit 300A, the bonding pad 651 can transmit and receive RF signals and provide a direct-current (DC) bias voltage with a DC reference signal level for the single antenna 602. In other words, the pad 651 can serve as both an RF pad and a DC bias pad. The structure of circuit 300A can be applied to the architectures mentioned above, such as FIG. 1, FIG. 5, and FIG. 8, which have a single RF pad.

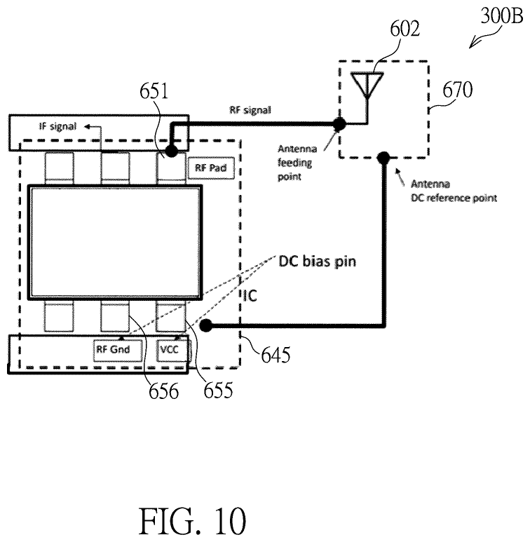

FIG. 10 illustrates a circuit 300B according to another embodiment. The similarities between circuit 300B and circuit 300A will not be reiterated. In the circuit 300B, the bonding pad 651 of an IC 645 can be coupled to the single pad 602 to transmit and receive RF signals. At least one of the bonding pads 655 and 656 of the IC 645, or a part of IC 645 with a DC level (such as an appropriate conductive layer), can be coupled to the single antenna 602 to provide a DC bias voltage with a DC reference level. For example, in the IC 645, the bonding pad 655 can provide a predetermined reference voltage (often referred to as VCC), and the bonding pad 656 can provide a ground voltage (often referred to as GND).

As shown in FIG. 10, the single antenna 602 can be disposed on the antenna element 670. The antenna element 670 can include an antenna feeding point for receiving and transmitting RF signals, and an antenna DC reference point for receiving the DC reference bias voltage. In FIG. 10, the IC 645 and the antenna element 670 can form a loop.

The ICs in FIG. 9 and FIG. 10 are illustrated with 6 bonding pads, but this is an example to indicate that an IC can have multiple bonding pads and is not intended to limit the number of bonding pads on the IC.

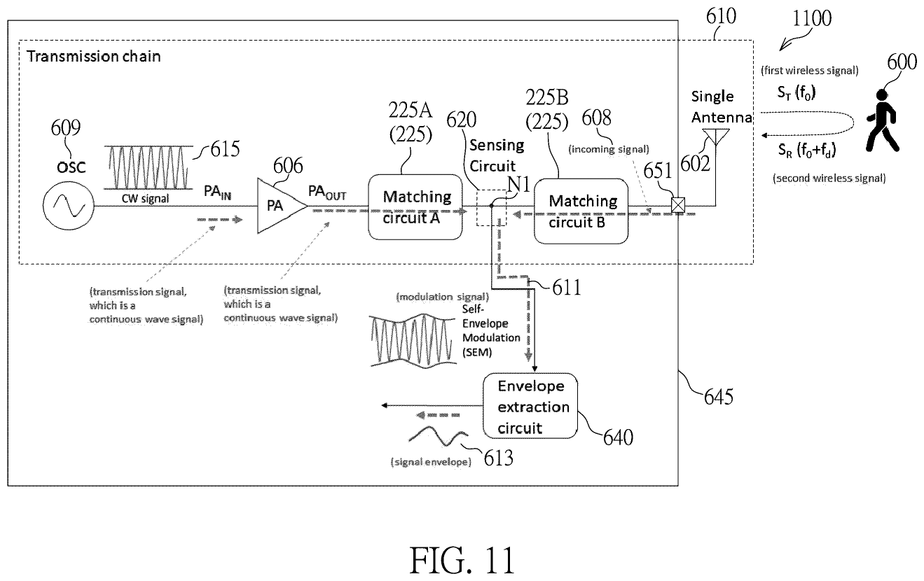

In FIG. 1 and FIG. 3 to FIG. 8, each of the circuits 60, 70, 80, 90, 100, and 200 can include the detector circuit 660. However, according to embodiments, each circuit can also not include the detector circuit 660 and instead output the signal envelope 613 to an external detection circuit to determine whether the object 600 is moving, and this also falls within the scope of the embodiments. For example, FIG. 11 shows an instance where the detector circuit 660 is not included.

FIG. 11 illustrates a circuit 1100 for detecting motion of an object 600 in an environment according to another embodiment. In FIG. 11, a transmission chain 610 can include a power amplifier 606, a sensing circuit 620, a matching circuit 225, and a single antenna 602 coupled together. The transmission chain 610 can be used to transmit, by the single antenna 602, a first wireless signal S_{T}(f₀) related to a transmission signal PA_{OUT}. The transmission signal PA_{OUT} can be a continuous wave signal. The single antenna 602 can be used to receive a second wireless signal S_{R}(f₀+f_{d}) as an incoming signal 608. The second wireless signal S_{R}(f₀+f_{d}) can be a reflected first wireless signal S_{T}(f₀) from the object 600. The sensing circuit 620 can be used to obtain a modulation signal 611 by combining the continuous wave signal and the incoming signal 608, wherein the modulation signal 611 can contain a Doppler shift caused by the motion of the object 600. The matching circuit 225 can be used to adjust an impedance looked into the single antenna 602. A signal envelope 613 generated according to the modulation signal 611 can be used to determine detection of the motion of the object 600.

The circuit 1100 in FIG. 11 can be similar to the circuit 200 in FIG. 7, but the detector circuit 660 of the circuit 1100 can be omitted or can be moved outside the IC 645. In FIG. 11, the envelope extraction circuit 640 can output the signal envelope 613 via another pad to an external detection circuit to determine whether the object 600 is moving. In FIG. 11, the matching circuit 225 can include a matching circuit 225A and/or a matching circuit 225B. Similar to the above, in FIG. 11, either one of the matching circuits 225A and 225B can be installed and used, or both can be used, which falls within the scope of embodiments. In FIG. 11, a bonding pad 651 can be located between the matching circuit 225B and the single antenna 602, so both matching circuits 225A and 225B can be inside the IC 645. However, this is an example. If the bonding pad 651 is located between the sensing circuit 620 and the matching circuit 225B, then the matching circuit 225B can be outside the IC 645, which can provide more flexible configurations.

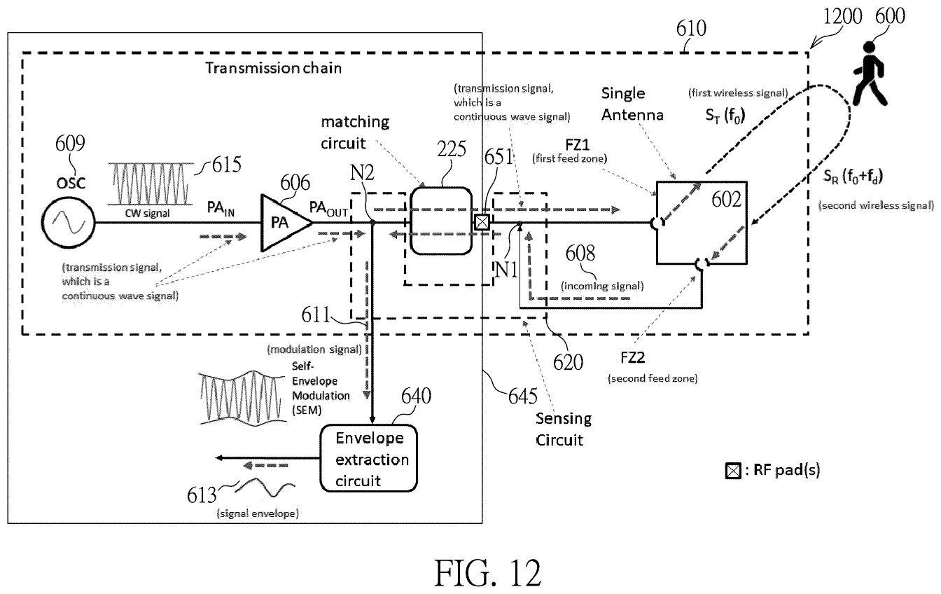

FIG. 12 illustrates a circuit 1200 for detecting motion of an object 600 in an environment according to another embodiment. In FIG. 12, the single antenna 602 can include a first feed zone FZ1 and a second feed zone FZ2. The first wireless signal S_{T}(f₀) can be transmitted to the single antenna 602 through the first feed zone FZ1. The second wireless signal S_{R}(f₀+f_{d}) can be received by the single antenna 602 as the incoming signal 608. The sensing circuit 620 can be used to obtain the modulation signal 611 by combining the continuous wave signal corresponding to the transmission signal PA_{OUT} and the incoming signal 608 through the second feed zone FZ2. In this embodiment, the single antenna 602 can be a dual-orthogonal polarization antenna, and the isolation between the first wireless signal S_{T}(f₀) and the second wireless signal S_{R}(f₀+f_{d}) may greater than 60 dB.

The circuit 1200 may include a matching circuit 225 to adjust an impedance looked into the single antenna 602. The first wireless signal S_{T}(f₀) can be transmitted by the single antenna 602 according to the transmission signal passing through the matching circuit 225 and the first feed zone FZ1. The sensing circuit 620 can be used to obtain the modulation signal 611 by combining the continuous wave signal corresponding to the transmission signal PA_{OUT} and the incoming signal 608 through the second feed zone FZ2 and the matching circuit 225.

In FIG. 12, a bonding pad 651 can be located between the matching circuit 225 and a node NI of the sensing circuit 620. The node N1 of the sensing circuit 620 can be located outside the IC 645, and a node N2 of the sensing circuit 620 can be located in the IC 645. In FIG. 12, the oscillator 609, the power amplifier 606, the matching circuit 225, and the envelope extraction circuit 640 can be on the IC 645, which can provide more compact configurations.

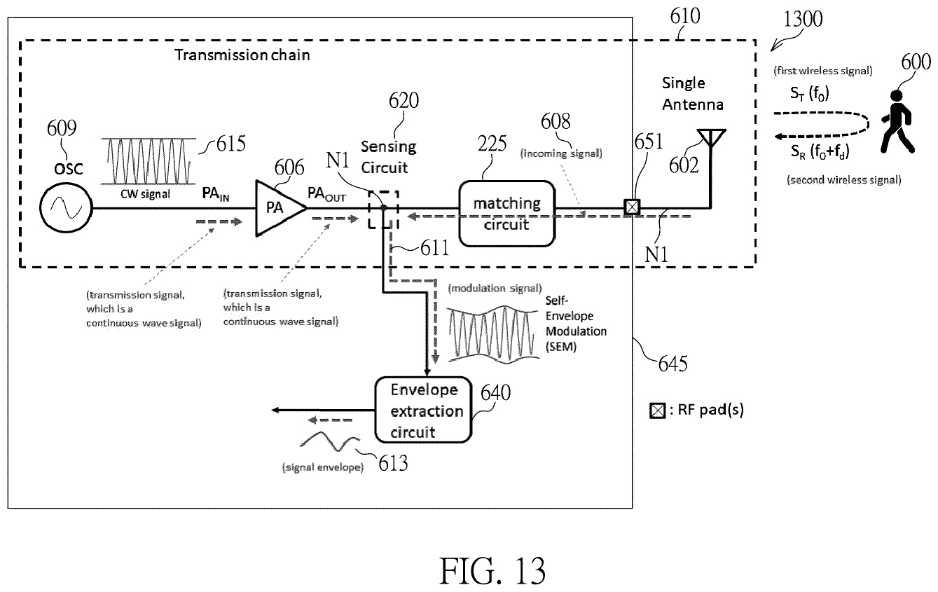

FIG. 13 illustrates a circuit 1300 for detecting motion of an object 600 in an environment according to another embodiment. As shown in FIG. 13, the power amplifier 606, the sensing circuit 620, the envelope extraction circuit 640 and the matching circuit 225 can be disposed on the IC 645, which can provide more compact configurations. The IC 645 can include the bonding pad 651. The power amplifier 606, the sensing circuit 620, the matching circuit 225, the bonding pad 225 and the single antenna 602 can be coupled in sequence as shown in FIG. 13.

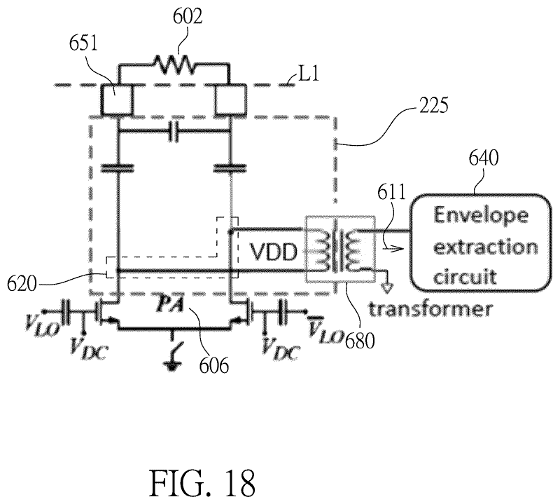

FIG. 14 to FIG. 18 illustrate a plurality of circuits according to embodiments, where each figure shows a circuit including a power amplifier, a matching circuit, and an envelope extraction circuit. The circuits in FIG.14 and FIG.18 can be related to the aforementioned circuits with matching circuits.

In FIG. 14 to FIG. 18, the components located below the reference line L1 can be inside the IC, and the component (e.g., the single antenna 602) located above the reference line L1 can be outside the IC. The directions (up, down, left, right) in the figures are for illustrative purposes only, to explain the circuit structure, and do not represent the exact circuit layout. In FIG. 14 to FIG. 18, the single antenna 602 can be represented by an equivalent resistance. For example, the equivalent resistance of the antenna 602 can be between 40 and 60 ohms, for instance, around 50 ohms.

In FIG. 14 to FIG. 18, the power amplifier 606, the sensing circuit 620, the envelope extraction circuit 640 and the matching circuit 225 can be disposed on the IC. The IC can include a bonding pad 651. The power amplifier 606, the sensing circuit 620, the matching circuit 225, the bonding pad 651, and the single antenna 602 can be coupled in sequence. The single antenna 602 is replaced with a resistance symbol to represent its equivalent impedance.

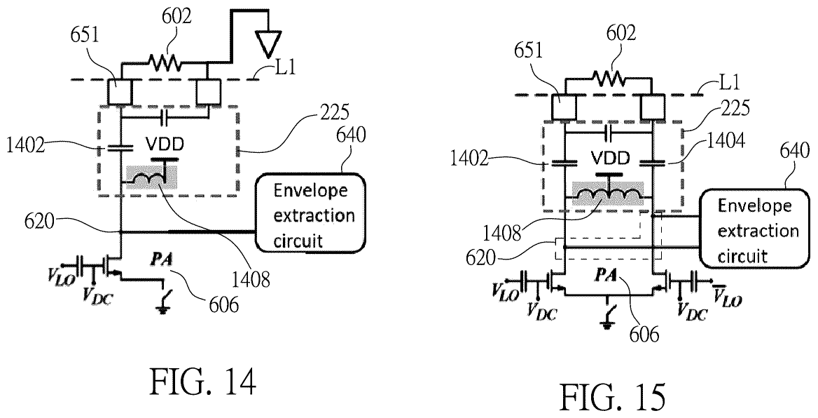

As shown in FIG. 14 to FIG. 18, the matching circuit 225 can include a capacitor coupled between the power amplifier 606 and the bonding pad 651. In FIG. 14, the matching circuit 225 can include a capacitor 1402. In FIG. 15 to FIG. 18, the matching circuit 225 can include capacitors 1402 and 1404.

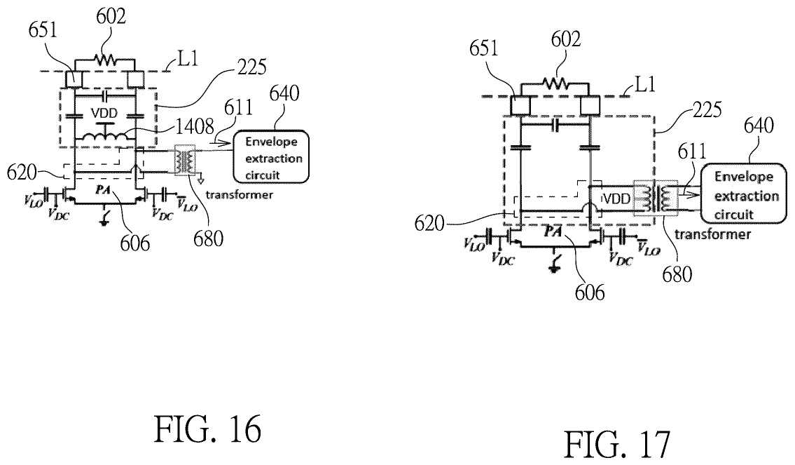

As shown in FIG. 14, FIG. 15 and FIG. 16, the matching circuit 225 can include an inductor 1408 coupled between the power amplifier 606 and a reference voltage terminal VDD. The inductor 1408 can be used as a choke inductor for the power amplifier 606.

As shown in FIG. 16, FIG. 17, and FIG. 18, a transformer 680 can be used. The sensing circuit 620 can be used to obtain the modulation signal 611 and send the modulation signal 611 to the envelope extraction circuit 640 via the transformer 680.

The first winding of the transformer 680 (the winding located at the input terminal of the transformer 680) can be used as a choke inductor for the power amplifier 606. If the first winding of the transformer 680 is coupled to the reference voltage terminal VDD, the first winding can be used as a choke inductor for the power amplifier 606 as shown in FIG. 17 and FIG. 18.

Different from FIG. 17, in FIG. 18, one terminal of the second winding of the transformer 680 can be coupled to terminal 640, and the other terminal can be coupled to a predetermined voltage terminal (for example, ground terminal or low voltage terminal).

In FIG. 15 to FIG. 18, the signal V_{LO} is the transmission signal PA_{IN} which can be input to the power amplifier 606 to be amplified. The power amplifier 606 can receive a signal V_{DC} to receive a predetermined bias voltage. A switch can be coupled between the power amplifier 606 and a predetermined voltage terminal (e.g., ground terminal) to assist in turning the power amplifier 606 on or off.

In FIG. 15, FIG. 16, FIG. 17, and FIG. 18, the power amplifier 606 can receive differential signals for amplification, where the signals V_{LO} and V̅_{LO} input into the power amplifier 606 can be complementary differential signals.

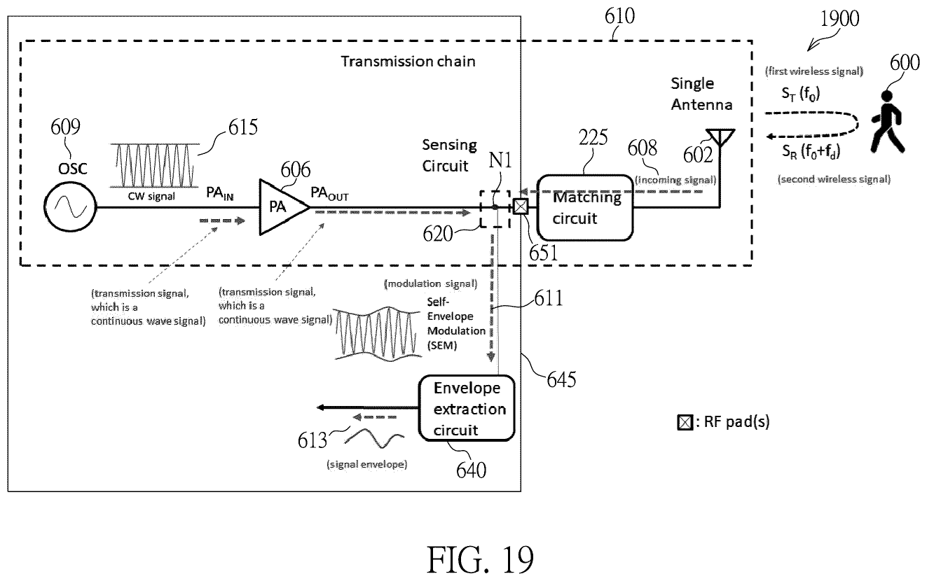

FIG. 19 illustrates a circuit 1900 for detecting motion of an object 600 in an environment according to another embodiment. In FIG. 19, the power amplifier 606, the sensing circuit 620, and the envelope extraction circuit 640 can be disposed on an IC 645. The IC 645 can include the bonding pad 651 (RF pad). The power amplifier 606, the sensing circuit 620, the bonding pad 651, the matching circuit 225, and the single antenna 602 can be coupled in sequence. In FIG. 19, the abovementioned detector circuit 660 of the circuit 1900 can be omitted or can be moved outside the IC 645, and the envelope extraction circuit 640 can output the signal envelope 613 via another pad to an external detection circuit to determine whether the object 600 is moving.

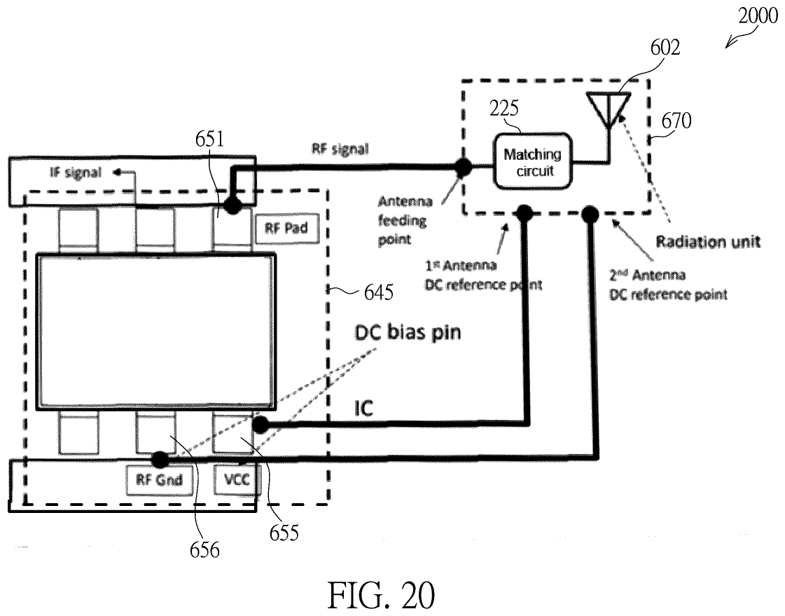

FIG. 20 illustrates a circuit 2000 for detecting motion of an object 600 in an environment according to another embodiment. In FIG. 20, the matching circuit 225 and the single antenna 602 can be disposed in a printed circuit board (PCB) and located outside the IC 645. The IC 645 can include bonding pads 651, 655 and 656. The structure in FIG. 20 can have a single RF pad (e.g., the bonding pad 651) and two DC pads (e.g., the bonding pads 655 and 656). The bonding pad 651 can be an RF pad for transmitting and receiving RF signals (e.g., AC signals). The bonding pad 656 can receive a reference voltage, and the reference voltage can be provided to the single antenna 602 through the bonding pad 656. For example, the reference voltage received by the bonding pad 656 can be a ground voltage. The bonding pad 655 can receive a DC bias voltage (referred to as VCC), and the DC bias voltage can be provided to the single antenna 602 through the bonding pad 655.

As shown in FIG. 20, the single antenna 602 can be disposed on the antenna element 670. In FIG. 20, the antenna element 670 can have an antenna feeding point for receiving and transmitting RF signals. The antenna element 670 can also have a first antenna DC reference point for receiving a reference voltage (e.g., VCC). Additionally, the antenna element 670 can have a second antenna DC reference point for receiving another reference voltage (e.g., GND).

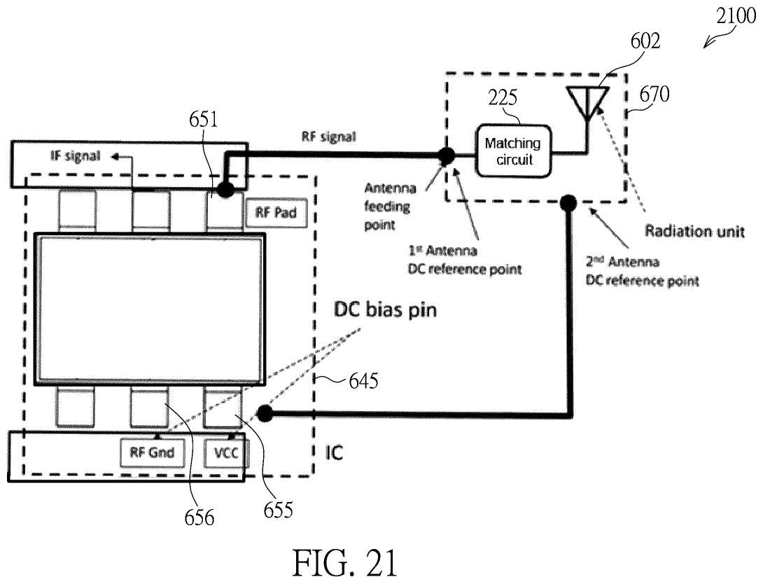

FIG. 21 illustrates a circuit 2100 for detecting motion of an object 600 in an environment according to another embodiment. In FIG. 21, the matching circuit 225 and the single antenna 602 can be disposed in a PCB and located outside the IC 645. The IC 645 can include bonding pads 651 and 656. The bonding pad 656 can receive a reference voltage, and the reference voltage can be provided to the single antenna 602 through the bonding pad 602. For example, the reference voltage of the bonding pad 656 can be an RF ground voltage; that is to say, the reference voltage can have a ground reference level for the RF signals. In FIG. 21, the bonding pad 651 can be an RF pad for receiving and transmitting RF signals. The bonding pad 651 can also receive a DC bias voltage, and the DC bias voltage can be provided to the single antenna 602 through the bonding pad 651.

As shown in FIG. 21, the single antenna 602 can be disposed on the antenna element 670. The antenna element 670 can include a first point and a second point. The first point can be an antenna feeding point for receiving and transmitting RF signals, and can also serve as a first antenna DC reference point for receiving a first reference voltage. The second point can be a second antenna DC reference point for receiving a second reference voltage.

In summary, as illustrated in FIG. 1, FIG. 4 to FIG. 8, FIG. 11 to FIG. 13, and FIG. 19, the sensing circuit can be formed using either one node or two nodes to combine signals and generate a modulation signal (which can be an SEM signal). As shown in FIG. 6, the sensing circuit may include a coupling element to adjust the combination of signals. As depicted in FIG. 3, for a single antenna, the isolation between the feed zones can be adjusted to combine signals via signal leakage, producing a modulation signal (which can be an SEM signal). This modulation signal can then be used to generate a signal envelope to determine whether an object is moving. Additionally, embodiments provide solutions for the arrangement and utilization of matching circuits and bonding pads. As a result, the size and complexity of the circuits can be effectively reduced while achieving accurate object movement detection.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit for detecting motion of an object in an environment, the circuit comprising:
a transmission chain including a power amplifier, a sensing circuit, and a single antenna coupled together, the transmission chain configured to transmit, by the single antenna, a first wireless signal related to a transmission signal, wherein:
the transmission signal is a continuous wave signal;
the single antenna is configured to receive a second wireless signal as an incoming signal, the second wireless signal being a reflected first wireless signal from the object; and
the sensing circuit is configured to obtain a modulation signal by combining the continuous wave signal and the incoming signal, wherein the modulation signal contains a Doppler shift caused by the motion of the object;
an envelope extraction circuit configured to extract a signal envelope varied by the Doppler shift from the modulation signal; and
a detector circuit configured to determine detection of the motion of the object in accordance with the signal envelope.

2. The circuit for detecting motion of claim 1, wherein the detector circuit further configured to:
determine whether a signal level of the signal envelope exceeds a predetermined threshold; and
responsive to the determination that the signal level of the signal envelope exceeds the predetermined threshold, determine detection of the motion of the object.

3. The circuit for detecting motion of claim 2, wherein the detector circuit further configured to:
determine whether the signal level of the signal envelope exceeds the predetermined threshold in frequency domain; and
responsive to the determination that the signal level of the signal envelope exceeds the predetermined threshold in frequency domain, determine detection of the motion of the object.

4. The circuit for detecting motion of claim 1, wherein the single antenna further comprises a first feed zone and a second feed zone, wherein:
the first wireless signal is transmitted to the single antenna through the first feed zone;
the second wireless signal is received by the single antenna as the incoming signal;
the sensing circuit is configured to obtain the modulation signal through the second feed zone by combining the continuous wave signal leaked from the first feed zone and the incoming signal.

5. The circuit for detecting motion of claim 4, wherein:
the sensing circuit is formed by the second feed zone; and
an isolation between the first wireless signal and the second wireless signal is not less than 7 dB and is not greater than 60 dB.

6. The circuit for detecting motion of claim 1, wherein the single antenna further comprises a first feed zone and a second feed zone, wherein:
the first wireless signal is transmitted to the single antenna through the first feed zone;
the second wireless signal is received by the single antenna as the incoming signal;
the sensing circuit is configured to obtain the modulation signal by combining the continuous wave signal and the incoming signal through the second feed zone.

7. The circuit for detecting motion of claim 1, wherein the single antenna further comprises a first feed zone and a second feed zone, wherein:
the first wireless signal is transmitted to the single antenna through the first feed zone;
the second wireless signal is received by the single antenna as the incoming signal;
the sensing circuit is configured to obtain the modulation signal by combining the continuous wave signal through a coupling element and the incoming signal through the second feed zone.

8. The circuit for detecting motion of claim 1, wherein the transmission chain further comprises a matching circuit configured to adjust an impedance looked into the single antenna.

9. The circuit for detecting motion of claim 1, wherein:
the power amplifier, the sensing circuit, the envelope extraction circuit and the detector circuit are disposed in an integrated circuit; and
the integrated circuit further comprises a first bonding pad, and the first bonding pad is the same bonding pad configured to provide RF signal transmission between the power amplifier and the single antenna of the transmission chain, and between the single antenna and the envelope extraction circuit of the transmission chain.

10. The circuit for detecting motion of claim 9, wherein:
the first bonding pad is further configured to receive a DC bias voltage, and the DC bias voltage is provided to the single antenna through the first bonding pad; or
the integrated circuit further comprises a second bonding pad configured to receive the DC bias voltage, and the DC bias voltage is provided to the single antenna through the second bonding pad.

11. A circuit for detecting motion of an object in an environment, the circuit comprising:
a transmission chain including a power amplifier, a sensing circuit, a matching circuit, and a single antenna coupled together, the transmission chain configured to transmit, by the single antenna, a first wireless signal related to a transmission signal, wherein:
the transmission signal is a continuous wave signal;
the single antenna is configured to receive a second wireless signal as an incoming signal, the second wireless signal being a reflected first wireless signal from the object; and
the sensing circuit is configured to obtain a modulation signal by combining the continuous wave signal and the incoming signal, wherein the modulation signal contains a Doppler shift caused by the motion of the object; and
wherein the matching circuit is configured to adjust an impedance looked into the single antenna, and a signal envelope generated according to the modulation signal is configured to determine detection of the motion of the object.

12. The circuit for detecting motion of claim 11, wherein the single antenna further comprises a first feed zone and a second feed zone, wherein:
the first wireless signal is transmitted to the single antenna through the first feed zone;
the second wireless signal is received by the single antenna as the incoming signal;
the sensing circuit is configured to obtain the modulation signal by combining the continuous wave signal and the incoming signal through the second feed zone.

13. The circuit for detecting motion of claim 12, wherein:
the first wireless signal is further transmitted to the single antenna through the matching circuit and the first feed zone;
the sensing circuit is configured to obtain the modulation signal by combining the continuous wave signal and the incoming signal through the second feed zone and the matching circuit.

14. The circuit for detecting motion of claim 12, wherein:
the power amplifier, the sensing circuit, the envelope extraction circuit and the matching circuit are disposed in an integrated circuit;
the integrated circuit further comprises a first bonding pad, and the power amplifier, the sensing circuit, the matching circuit, the first bonding pad and the single antenna are coupled in sequence.

15. The circuit for detecting motion of claim 14, wherein:
the matching circuit comprises a capacitor coupled between the power amplifier and the first bonding pad.

16. The circuit for detecting motion of claim 15, wherein:
the matching circuit further comprises an inductor coupled between the power amplifier and a reference voltage terminal.

17. The circuit for detecting motion of claim 15 further comprising a transformer, wherein:
the sensing circuit is configured to obtain the modulation signal via the transformer.

18. The circuit for detecting motion of claim 12, wherein:
the power amplifier, the sensing circuit and the envelope extraction circuit are disposed in an integrated circuit;
the integrated circuit further comprises a first bonding pad, and the power amplifier, the sensing circuit, the first bonding pad, the matching circuit and the single antenna are coupled in sequence.

19. The circuit for detecting motion of claim 18, wherein:
the matching circuit and the single antenna are disposed in a printed circuit board;
the integrated circuit further comprises a second bonding pad and a third bonding pad;
the second bonding pad is further configured to receive a reference voltage, and the reference voltage is provided to the single antenna through the second bonding pad; and
the third bonding pad is further configured to receive a DC bias voltage, and the DC bias voltage is provided to the single antenna through the third bonding pad.

20. The circuit for detecting motion of claim 18, wherein:
the matching circuit and the single antenna are disposed in a printed circuit board;
the integrated circuit further comprises a second bonding pad;
the second bonding pad is further configured to receive a reference voltage, and the reference voltage is provided to the single antenna through the second bonding pad; and
the first bonding pad is further configured to receive a DC bias voltage, and the DC bias voltage is provided to the single antenna through the first bonding pad.
